(19) United States
(12) Patent Application Publication
(10) Pub. No.: US 2002/0082909 A1
(43) Pub. Date: Jun. 27, 2002

(54) Print processing system and method with interface advertising

(76) Inventor: George Bradley Hobbs, Star, ID (US)

Correspondence Address: HEWLETT-PACKARD COMPANY, Intellectual Property Administration, P.O. Box 272400, Fort Collins, CO, 80527-2400, US

(21) Appl. No.: 09/734,290

(22) Filed: Dec. 11, 2000

(51) Int. Cl. G06F 17/60; H04N 1/46

(52) U.S. Cl. 705/14; 358/500

(57) ABSTRACT

A system and method of processing a print job of a customer and directing advertising to the customer includes defining a network communication link between the customer and a print processing system controller having an advertisement registered therewith. The print processing system controller processes a job ticket for the print job and presents the advertisement to the customer via the network communication link when processing the job ticket.

### CROSS-REFERENCE TO RELATED APPLICATIONS

This application is related to Non-Provisional U.S. patent application Ser. No. XX/XXX,XXX, entitled “PRINT PROCESSING SYSTEM AND METHOD WITH PRINT JOB ADVERTISING”, having Attorney Docket No. 10003974-1, filed on even date herewith, assigned to the assignee of the present invention, and incorporated herein by reference.

### THE FIELD OF THE INVENTION

The present invention relates generally to print services and, more particularly, to a network system and method of processing a print job of a customer and directing advertising to the customer.

### BACKGROUND OF THE INVENTION

Typically, advertising is conducted for specific consumer segments in specific media forms. As such, an advertiser attempts to define a respective consumer segment to whom to target the advertising as well as an effective media form for conveying the advertising.

As one form of advertising, print advertising often accompanies printed material. Thus, establishing a nexus between the print advertising and the printed material is advantageous to the advertiser. For example, if a consumer creating and/or reading the printed material has an interest in an aspect of the printed material, then assumedly the consumer may have an interest in a subject matter of the print advertising.

An advertiser, therefore, can target print advertising to a consumer based on an aspect of accompanying printed material. Targeting print advertising to the consumer, however, is often difficult since the advertiser is not always aware of when printed material relevant to the subject matter of the print advertising is being printed.

Accordingly, a need exists for processing a print job of a customer and directing advertising to the customer. More particularly, a need exists for targeting advertising to the customer based on an aspect of the print job including at least one attribute of the print job.

### SUMMARY OF THE INVENTION

One aspect of the present invention provides a method of processing a print job of a customer and directing advertising to the customer. The method includes defining a print processing system controller having an advertisement registered therewith, defining a network communication link between the customer and the print processing system controller, processing a job ticket for the print job with the print processing system controller, and presenting the advertisement to the customer via the network communication link when the print processing system controller processes the job ticket for the print job.

Another aspect of the present invention provides a method of processing a print job of a customer and directing advertising to the customer. The method includes defining a print processing system controller having a plurality of advertisements registered therewith, defining a network communication link between the customer and the print processing system controller, processing a job ticket for the print job with the print processing system controller and selecting at least one of the advertisements based on the job ticket, and presenting the at least one of the advertisements to the customer via the network communication link.

Another aspect of the present invention provides a system for processing a print job of a customer and directing advertising to the customer. The system includes a print processing system controller configured to have an advertisement registered therewith. As such, the print processing system controller is adapted to process a job ticket for the print job and present the advertisement to the customer when the print processing system controller processes the job ticket for the print job.

In one embodiment, the present invention provides a system and method of processing a print job of a customer and directing advertising to the customer. The system and method utilizes a network communication link between the customer and a controller of the system to efficiently and effectively direct advertising to the customer when the controller processes the print job.

### BRIEF DESCRIPTION OF THE DRAWINGS

FIG. 1 is a block diagram illustrating one exemplary embodiment of a print processing system according to the present invention.

FIG. 2 is a block diagram illustrating one exemplary embodiment of information flow through a portion of the print processing system of FIG. 1.

FIG. 3 is a diagram illustrating one exemplary embodiment of a job ticket generated and submitted by a customer with the print processing system of FIG. 1.

FIG. 4 is a block diagram illustrating one exemplary embodiment of information flow through another portion of the print processing system of FIG. 1.

FIG. 5 is a diagram illustrating one exemplary embodiment of a portion of a customer interface of the print processing system of FIG. 1.

FIG. 6 is a flow diagram illustrating one exemplary embodiment of a method of processing a print job of a customer according to the present invention.

FIG. 7 is a flow diagram illustrating one exemplary embodiment of a method of processing a job ticket in the method of FIG. 6.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

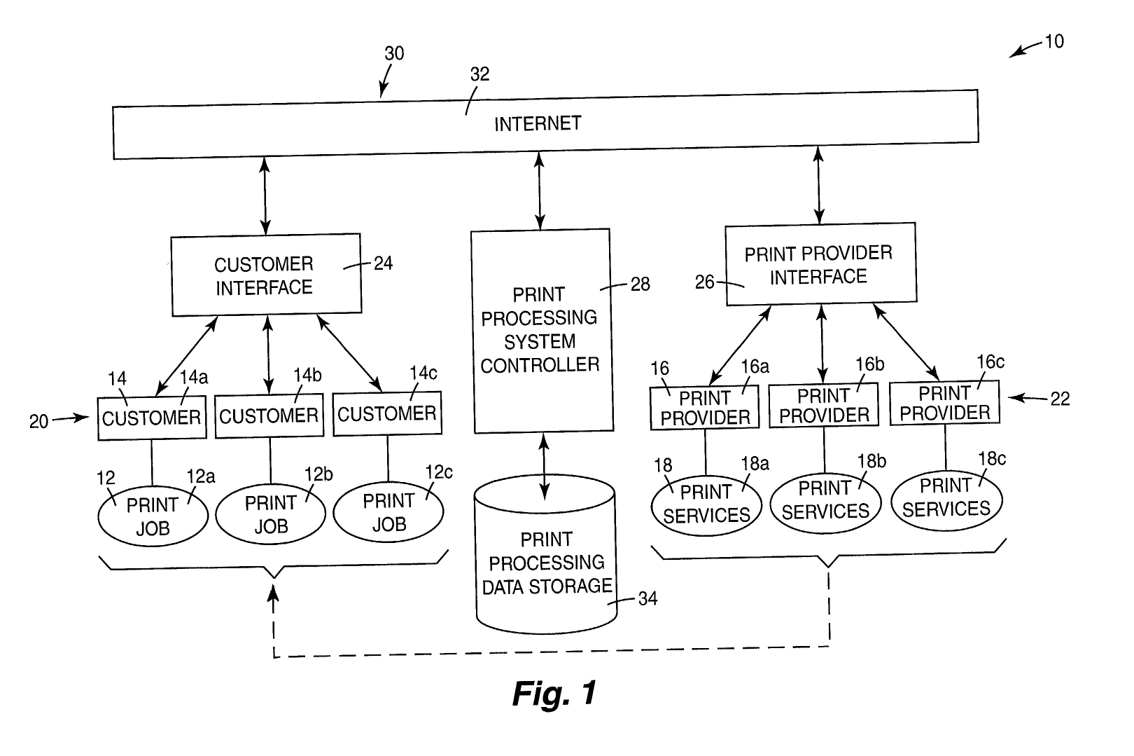

A network print processing system according to the present invention is illustrated generally at 10 in FIG. 1. Print processing system 10 facilitates processing of a print job 12 of a customer 14 before printing of print job 12 by a print provider 16 offering print services 18. In addition, print processing system 10 directs advertising to customer 14.

In one exemplary embodiment, print processing system 10 facilitates processing of a print job 12a, 12b, 12c of a customer 14a, 14b, 14c before printing of print job 12a, 12b, 12c by a print provider 16a, 16b, 16c offering print services 18a, 18b, 18c. For clarity, print job 12a, 12b, 12c, customer 14a, 14b, 14c, print provider 16a, 16b, 16c, and print services 18a, 18b, 18c are referred to hereinafter as print job 12, customer 14, print provider 16, and print services 18, respectively. As such, customer 14 may be one of a plurality of customers 20 each having a separate print job 12. Print provider 16 may be one of a plurality of print providers 22 each providing separate print services 18.

Print job 12, as used herein, is defined to include a piece of work requiring production and/or reproduction of printed matter. Customer 14, as used herein, is defined to include an entity or entities such as a consumer, an employee, or another print provider requesting or soliciting printing services, finishing services, delivery services, and/or other print processing services. Customer 14, therefore, includes any user of such printing, finishing, delivery, and/or other print processing services. Print provider 16, as used herein, is defined to include an entity or entities offering, providing, and/or assisting in printing services, finishing services, delivery services, and/or other print processing services. Print services 18, as used herein, is defined to include printing services, finishing services, delivery services, and/or other print processing services.

In one exemplary embodiment, print processing system 10 includes a customer interface 24, a print provider interface 26, and a print processing system controller 28. As such, customers 20 interact with customer interface 24 and print providers 22 interact with print provider interface 26. It is within the scope of the present invention for multiple customers 20 to each use the same customer interface 24 and/or for each customer 14 to have their own customer interface 24. In addition, multiple print providers 22 may each use the same print provider interface 26 and/or each print provider 16 may have their own print provider interface 26.

Customer interface 24, print provider interface 26, and print processing system controller 28 communicate with each other via a network communication link 30. Network communication link 30, as used herein, is defined to include an internet communication link such as an Internet communication link, an intranet communication link, or similar high-speed communication link. In one preferred embodiment, network communication link 30 includes an Internet communication link 32. While the following description only refers to Internet communication link 32, it is understood that the use of other network communication links is within the scope of the present invention. In addition, network communication link 30 may include a wireless communication link.

In one exemplary embodiment, customers 20, print providers 22, and print processing system controller 28 are all located remote from each other (i.e., at different locations). Thus, communications between customers 20 and print processing system controller 28, communications between print providers 22 and print processing system controller 28, and communications between customers 20 and print providers 22 are conducted over Internet communication link 32. Preferably, print providers 22 communicate with print processing system controller 28 via Internet communication link 32. It is, however, within the scope of the present invention for print providers 22 to communicate with print processing system controller 28 in other manners (e.g., a direct connection or communication link).

Print processing system 10, including print processing system controller 28, can be implemented in hardware via a microprocessor, programmable logic device, or state machine, in firmware, or in software within a given device. In one embodiment, at least a portion of the software programming is written in JAVA programming language, and each of the main components communicate via Internet communication link 32 using a communication bus protocol. For example, the present invention may or may not use a TCP/IP protocol suite for data transport. Other programming languages and communication bus protocols suitable for use with print processing system 10 will become apparent to those skilled in the art after reading the present application.

Print processing system controller 28 includes hardware, software, firmware, or a combination of these. In one preferred embodiment, print processing system controller 28 includes a computer server or other microprocessor based system capable of performing a sequence of logic operations. In addition, print processing system controller 28 can include a microprocessor embedded system/appliance incorporating tailored appliance hardware and/or dedicated single purpose hardware.

In one exemplary embodiment, print processing system 10 includes a print processing data storage system 34. Print processing data storage system 34 constitutes a database of one or more data files for print processing system 10.

Examples of print processing data storage system 34 include non-volatile memory (e.g., a hard disk drive or other persistent storage device) and may include volatile memory (e.g., random access memory (RAM)). Data is transferred to and from print processing data storage system 34 via print processing system controller 28. It is understood that print processing system controller 28 and print processing data storage system 34 may constitute a central print processing system.

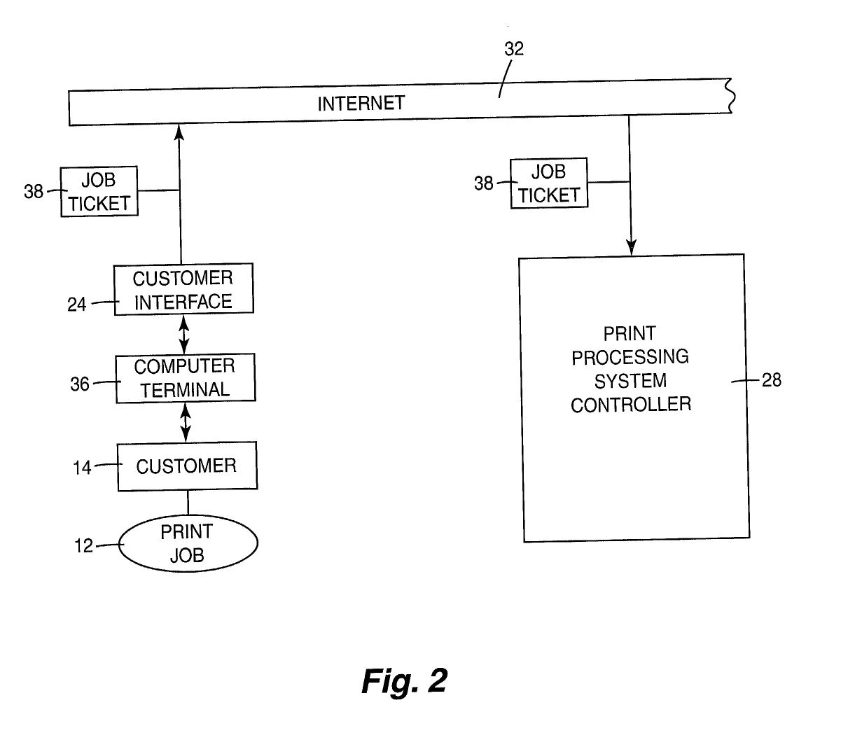

As illustrated in FIG. 2, customer 14 accesses customer interface 24 of print processing system 10 via a computer terminal 36. Computer terminal 36 may include, for example, an input device such as a keyboard and/or a mouse and a display device such as a monitor, as is well known in the art. In one exemplary embodiment, computer terminal 36 runs an operating system which can support one or more applications. The operating system is stored in memory and executes on a processor. The operating system is preferably a multi-tasking operating system which allows simultaneous execution of multiple applications, although aspects of this invention may be implemented using a single-tasking operating system.

In one exemplary embodiment, customer 14 interacts with customer interface 24 via computer terminal 36 to generate a job ticket 38 for print job 12 and submit job ticket 38 to print processing system controller 28 via Internet communication link 32. As such, print processing system controller 28 receives job ticket 38 from customer 14, processes job ticket 38, and distributes job ticket 38 to print provider 16 as described, for example, in U.S. patent application Attorney Docket No. 10003972-1, assigned to the assignee of the present invention and incorporated herein by reference. Job ticket 38 identifies attributes of print job 12 as specified by customer 14. Job ticket 38, as used herein, is defined to include a list and/or a description of a piece of work requiring production and/or reproduction of printed matter.

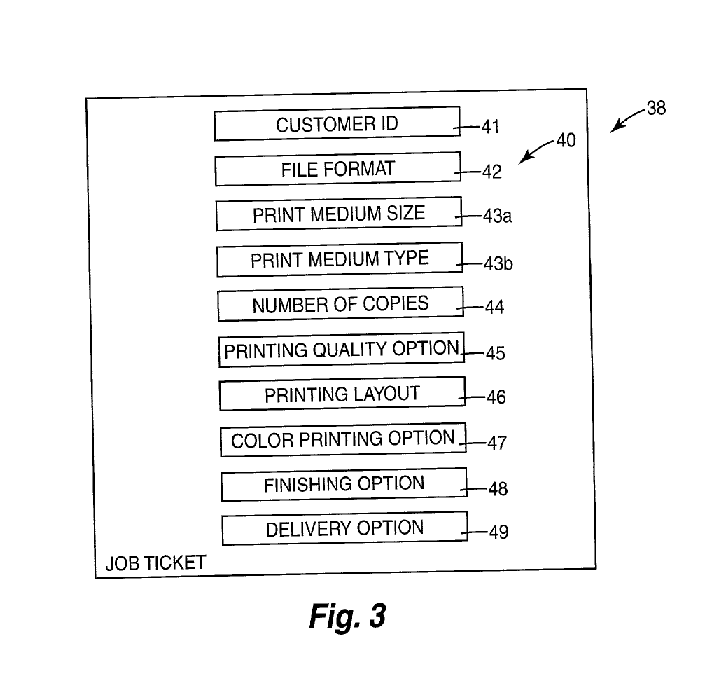

In one exemplary embodiment, as illustrated in FIG. 3, job ticket 38 includes a plurality of job ticket attributes 40 which define print job 12. Job ticket attributes 40 coincide with selections as specified by customer 14 while interacting with customer interface 24. As such, job ticket attributes 40 are conveyed to print processing system controller 28 from customer interface 24. Job ticket attributes 40 include, for example, a customer identification attribute 41, a file format attribute 42, a print medium size attribute 43a, a print medium type attribute 43b, a number of copies attribute 44, a printing quality option attribute 45, a printing layout attribute 46, a color printing option attribute 47, a finishing option attribute 48, and a delivery option attribute 49.

Customer identification attribute 41 includes, for example, the name and the address of customer 14. File format attribute 42 includes the format of the file from which print job 12 is to be printed. Print medium size attribute 43a includes a selected or desired size of medium upon which print job 12 is to be printed. Print medium type attribute 43b includes a selected or desired type of medium upon which print job 12 is to be printed. Number of copies attribute 44 includes the number of copies included in print job 12. Printing quality option attribute 45 includes a selected or desired printing quality for print job 12. Printing layout attribute 46 includes a selected or desired layout of how print job 12 is to be printed. Color printing option attribute 47 includes a selected or desired color content for print job 12. Finishing option attribute 48 includes a selected or desired finish to be applied to print job 12. Delivery option attribute 49 includes how and within what time frame print job 12 is to be delivered to customer 14. It is understood that not all attributes need be specified and that additional attributes may be included in job ticket 38.

In one exemplary embodiment, print processing system controller 28 infers or determines a number of job ticket attributes 40 from a data file submitted with job ticket 38 for print job 12. Print processing system controller 28 determines, for example, file format attribute 42, print medium size attribute 43a, and printing layout attribute 46 of print job 12 from the data file. Customer 14, therefore, need only enter those job ticket attributes 40 which are not determined by print processing system controller 28. As such, it is not necessary for customer 14 to enter all job ticket attributes 40.

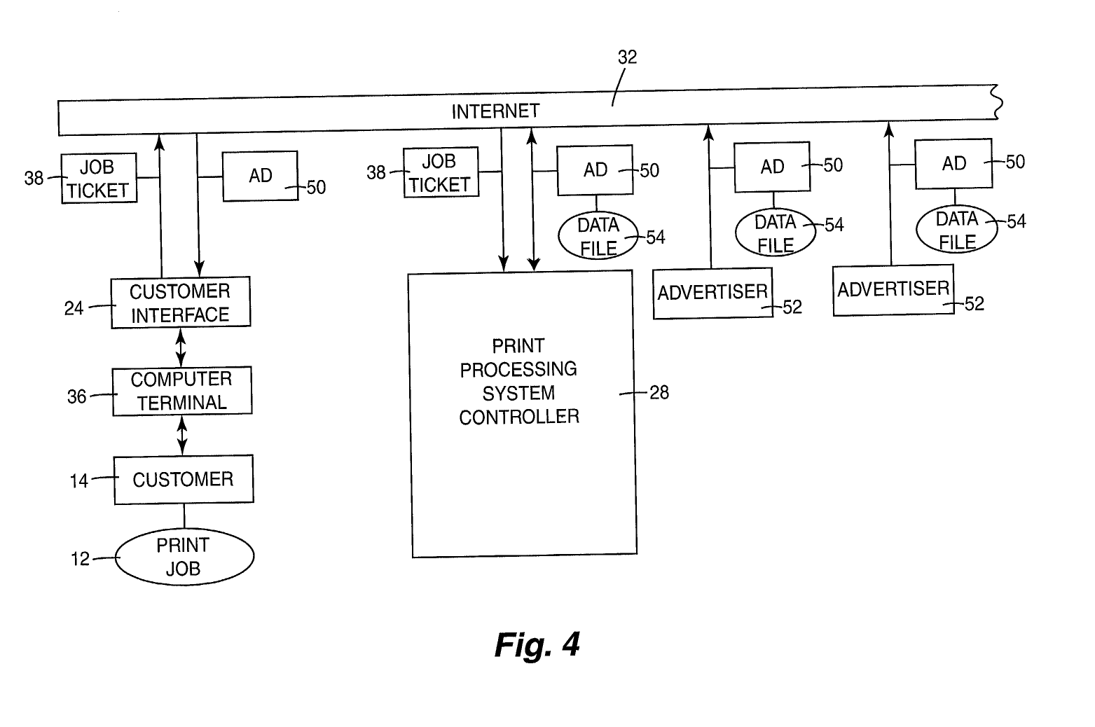

As illustrated in FIG. 4, print processing system controller 28 automatically directs advertising to customer 14. As such, print processing system controller 28 receives, processes, and distributes an advertisement 50 of an advertiser 52. More specifically, print processing system controller 28 presents advertisement 50 to customer 14. In one exemplary embodiment, print processing system controller 28 presents advertisement 50 to customer 14 when job ticket 38 is processed.

In one exemplary embodiment, advertiser 52 is located remote from print processing system controller 28. Thus, communications between advertiser 52 and print processing system controller 28 are conducted over network communication link 30. Preferably, advertiser 52 communicates with print processing system controller 28 via Internet communication link 32. It is, however, within the scope of the present invention for advertiser 52 to communicate with print processing system controller 28 in other manners (e.g., a direct connection or communication link).

In one exemplary embodiment, distribution of advertisement 50 is initiated by advertiser 52 and managed by print processing system controller 28. Advertiser 52 initiates distribution of advertisement 50 by registering advertisement 50 with print processing system controller 28. Advertiser 52 registers advertisement 50 by submitting advertisement 50 to print processing system controller 28. In one exemplary embodiment, advertisement 50 is submitted to print processing system controller 28 via Internet communication link 32. It is understood that advertiser 52 may be one of a plurality of advertisers each offering a respective advertisement and that each advertiser 52 may offer one or more advertisements 50.

In one exemplary embodiment, print processing system controller 28 communicates with and transfers advertisement 50 of advertiser 52 to print processing data storage system 34 (FIG. 1). As such, print processing system controller 28 stores advertisement 50 in print processing data storage system 34 for subsequent retrieval, processing, and distribution. More specifically, when print processing system controller 28 receives advertisement 50 from advertiser 52, advertisement 50 is stored as a data file in print processing data storage system 34. Print processing system controller 28, therefore, subsequently retrieves advertisement 50 from print processing data storage system 34 for processing.

In one exemplary embodiment, advertisement 50 is targeted to print job 12. More specifically, print processing system controller 28 selects advertisement 50 based on at least one job ticket attribute 40 of print job 12 as specified with job ticket 38. As such, print processing system controller 28 processes job ticket 38 and determines which advertisement 50 pertains to print job 12 and, therefore, should be presented to customer 14.

To determine which advertisement 50 pertains to print job 12, a data file 54 is associated with advertisement 50. Data file 54 is registered along with advertisement 50 and uploaded to print processing system controller 28 via Internet communication link 32. As such, print processing system controller 28 stores data file 54 along with advertisement 50 in print processing data storage system 34 (FIG. 1) for subsequent processing.

In one exemplary embodiment, data file 54 includes a profile of advertisement 50 such as keywords and/or a theme for advertisement 50. As such, print processing system controller 28 considers job ticket attributes 40 for print job 12 and data file 54 for advertisement 50 when selecting advertisement 50. For example, if delivery option attribute 49 identifies “pick-up” of print job 12 by customer 14, print processing system controller 28 may select and present to customer 14 advertisement 50 which advertises courier services. Thus, customer 14 may learn of available alternatives for delivery of print job 12. In addition, print processing system controller 28 may select and present to customer 14 advertisement 50 based on, for example, where print job 12 is to be picked up (e.g., a location of print provider 16). Furthermore, print processing system controller 28 may select and present to customer 14 advertisement 50 based on where customer 14 is located as identified, for example, by customer identification attribute 41.

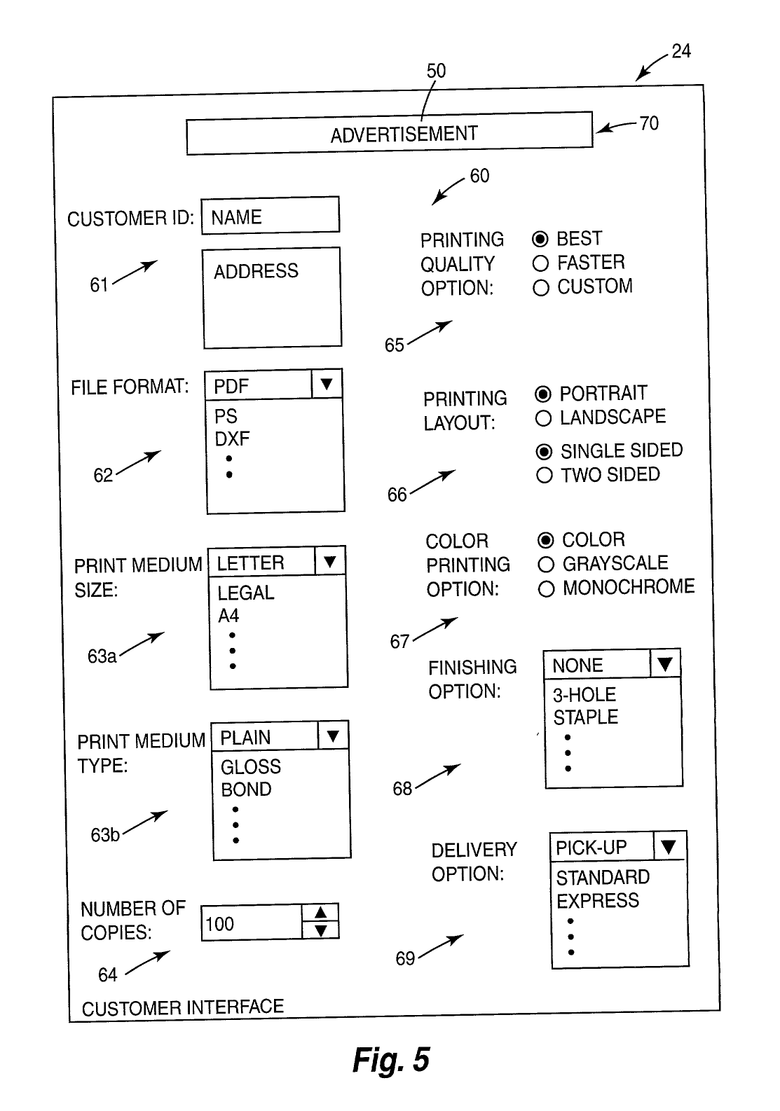

In one exemplary embodiment, as illustrated in FIG. 5, a portion of customer interface 24 includes a plurality of input fields 60 with which customer 14 interacts to specify job ticket attributes 40 of print job 12. As such, customer 14 interacts with input fields 60, via an input device such as a keyboard and/or a mouse of computer terminal 36 or an appliance such as a Personal Digital Assistant (PDA), scanner, camera, etc., to generate job ticket 38 for print job 12.

Input fields 60 include, for example, a customer identification field 61, a file format field 62, a print medium size field 63a, a print medium type field 63b, a number of copies field 64, a printing quality option field 65, a printing layout field 66, a color printing option field 67, a finishing option field 68, and a delivery option field 69. Input fields 60 each include at least one subfield providing data entry points or representing available options for generating and submitting job ticket 38.

Customer identification field 61 includes subfields which provide data entry points for a name and an address of customer 14. File format field 62 includes subfields which represent different file formats for print job 12. Print medium size field 63a includes subfields which represent different sizes of print medium for print job 12. Print medium type field 63b includes subfields which represent different types of print medium for print job 12. Number of copies field 64 includes a subfield in which a number of copies included in print job 12 is specified. Printing quality option field 65 includes subfields which represent different printing qualities, including different printing resolutions such as 1200 dpi, 600 dpi, 300 dpi, etc., for print job 12. Printing layout field 66 includes subfields which represent different printing layouts for print job 12. Color printing option field 67 includes subfields which represent different color printing options for print job 12. Finishing option field 68 includes subfields which represent different finishing options for print job 12. Delivery option field 69 includes subfields which represent different delivery options and turnaround times for print job 12.

Additional file formats, print medium sizes, print medium types, printing quality options, printing layouts, color printing options, finishing options, and delivery options, as are well known in the art, may be represented by additional subfields of file format field 62, print medium size field 63a, print medium type field 63b, printing quality option field 65, printing layout field 66, color printing option field 67, finishing option field 68, and delivery option field 69, respectively. Selecting and/or completing various subfields of input fields 60, therefore, identifies attributes of print job 12 as specified by customer 14.

In one exemplary embodiment, input of specific input fields 60 dictates a selection of other input fields 60. When customer 14 selects a specific subfield, for example, additional subfields may appear and/or existing subfields may be unavailable. In addition, when customer 14 selects a specific subfield, additional subfields may be automatically selected and/or completed. Furthermore, customer 14 may store preferences of various subfields as common default selections. Additional aspects of input fields 60 are described, for example, in above-incorporated U.S. patent application Attorney Docket No. 10003972-1.

Print processing system controller 28 presents advertisement 50 to customer 14 via customer interface 24 when job ticket 38 is processed, as described below. As such, a portion of customer interface 24 includes an advertisement field 70. Advertisement field 70 represents a region within which advertisement 50 is displayed. It is understood that advertisement field 70 may be sized, positioned, and/or oriented in a variety of manners and that multiple advertisement fields 70 may be provided.

In one exemplary embodiment, print processing system controller 28 presents advertisement 50 to customer 14 when job ticket 38 is generated. More specifically, print processing system controller 28 presents advertisement 50 to customer 14 as customer 14 interacts with customer interface 24 to generate job ticket 38. In one exemplary embodiment, print processing system controller 28 presents advertisement 50 to customer 14 when job ticket 38 is received. It is understood that multiple advertisements 50 may be presented to customer 14 while customer 14 interacts with customer interface 24 or when job ticket 38 is received. In one exemplary embodiment, advertisement 50 is presented to customer 14 via Internet communication link 32.

It is to be understood that FIG. 5 is a simplified illustration of one exemplary embodiment of customer interface 24. The illustrative presentation of input fields 60, including the respective subfields, and advertisement field 70 has been simplified for clarity of the invention. The subfields, for example, may be presented as open fields, pulldown menus, toggle selections, and/or highlighted or framed selections. In addition, customer interface 24 may be presented, for example, in one or more screens or views. Furthermore, customer 14 may generate job ticket 38 by responding to query-based systems or applications. It is understood that such alternatives are within the scope of the present invention.

In one exemplary embodiment, print provider interface 26 includes a plurality of input fields with which print provider 16 interacts, via an input device such as a keyboard and/or a mouse of a computer terminal, to register a printing capability which identifies attributes of print services 18 provided by print provider 16. Print provider 16 registers the printing capability with print processing system controller 28 in a manner similar to how customer 14 generates and submits job ticket 38 to print processing system controller 28. An example of print provider interface 26 is described in detail above-incorporated U.S. patent application Attorney Docket No. 10003972-1.

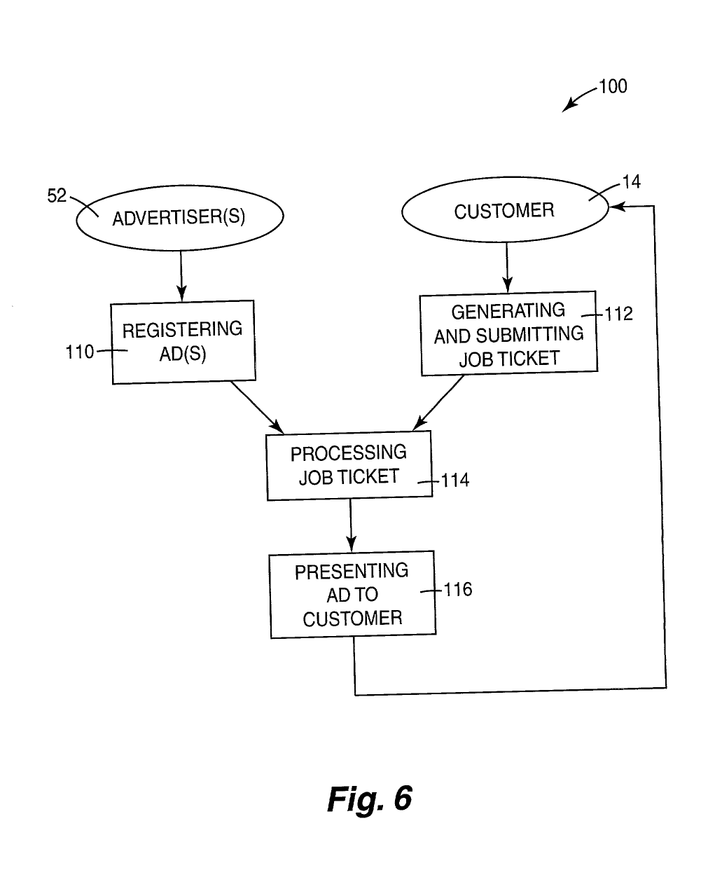

In FIG. 6, a flow diagram illustrating one exemplary embodiment of processing print job 12 and directing advertising to customer 14 according to the present invention is illustrated generally at 100. Reference is also made to FIGS. 1-5. At step 110, at least one advertiser 52 registers an advertisement 50, including data file 54, with print processing system controller 28 and, at step 112, customer 14 generates and submits job ticket 38 for print job 12 to print processing system controller 28. In one exemplary embodiment, customer 14 submits job ticket 38 to print processing system controller 28 via Internet communication link 32, as illustrated in FIG. 2, and advertiser 52 registers advertisement 50 with print processing system controller 28 via Internet communication link 32, as illustrated in FIG. 4.

Next, in step 114, print processing system controller 28 processes job ticket 38 and, in step 116, presents advertisement 50 to customer 14. In one exemplary embodiment, print processing system controller 28 presents advertisement 50 to customer 14 when job ticket 38 is generated. More specifically, as customer 14 interacts with customer interface 24 to generate job ticket 38, print processing system controller 28 presents advertisement 50 to customer 14. As such, processing of job ticket 38 by print processing system controller 28 in step 114 includes receiving an indication at print processing system controller 28 that customer 14 is generating job ticket 38. Such an indication includes, for example, customer 14 interacting with customer interface 24.

In one exemplary embodiment, print processing system controller 28 presents advertisement 50 to customer 14 when job ticket 38 is received. As such, processing of job ticket 38 by print processing system controller 28 in step 114 includes receiving, for example, at least one job ticket attribute 40 for print job 12.

When advertisement 50 of advertiser 52 is registered with print processing system controller 28 in step 110, print processing system controller 28 stores advertisement 50 in print processing data storage system 34, as described above. As such, print processing system controller 28 retrieves advertisement 50 from print processing data storage system 34 when processing job ticket 38 in step 114 and presenting advertisement 50 to customer 14 in step 116.

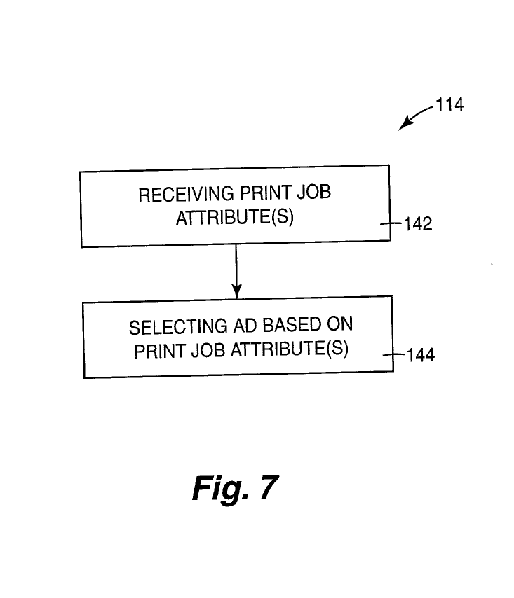

In one exemplary embodiment, as illustrated in FIG. 7, the step of processing job ticket 38 in step 114 includes receiving job ticket 38 for print job 12 and selecting advertisement 50 based on job ticket 38. More specifically, processing job ticket 38 in step 114 includes receiving at least one job ticket attribute 40 for print job 12 at print processing system controller 28, as indicated in step 142. As such, advertisement 50 is selected based on at least one job ticket attribute 40 for print job 12, as indicated in step 144. When selecting advertisement 50 in step 144, print processing system controller 28 considers job ticket attributes 40 and data file 54, as described above. Advertisement 50, therefore, is related to print job 12.

By including advertisement 50 with, for example, customer interface 24, print processing system 10 directs advertising to customer 14. More specifically, print processing system controller 28 processes job ticket 38 for print job 12 and presents advertisement 50 to customer 14 when processing job ticket 38. As such, print processing system 10 targets advertising to customer 14. In addition, by defining Internet communication link 32 between customer 14 and print processing system controller 28, advertisement 50 can be efficiently and effectively presented to customer 14.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of processing a print job of a customer and directing advertising to the customer, the method comprising the steps of:
defining a print processing system controller having an advertisement registered therewith;
defining a network communication link between the customer and the print processing system controller;
processing a job ticket for the print job with the print processing system controller; and
presenting the advertisement to the customer via the network communication link when the print processing system controller processes the job ticket for the print job.

2. The method of claim 1, wherein the step of defining the network communication link includes defining an Internet communication link between the customer and the print processing system controller.

3. The method of claim 1, wherein the print processing system controller has a plurality of advertisements registered therewith, and wherein the step of presenting the advertisement to the customer includes presenting at least one of the advertisements to the customer via the network communication link.

4. The method of claim 3, wherein the step of processing the job ticket includes receiving a plurality of attributes for the print job at the print processing system controller via the network communication link, and further comprising the step of:
selecting the at least one of the advertisements based on at least one of the attributes for the print job.

5. The method of claim 4, wherein receiving the plurality of attributes for the print job includes receiving at least one of a file format, a number of copies, a print medium, a printing layout, a printing quality option, a color printing option, a finishing option, a delivery option, and a customer identification for the printjob.

6. The method of claim 1, further comprising the step of:
registering the advertisement with the print processing system controller.

7. The method of claim 6, wherein the step of defining the network communication link includes defining the network communication link between at least one advertiser, the customer, and the print processing system controller, and wherein the step of registering the advertisement includes registering at least one advertisement of the at least one advertiser with the print processing system controller via the network communication link.

8. The method of claim 6, wherein the step of registering the advertisement includes storing the advertisement, and wherein the step of presenting the advertisement includes retrieving the advertisement.

9. The method of claim 1, wherein the step of processing the job ticket includes receiving the job ticket for the print job at the print processing system controller, and wherein the step of presenting the advertisement includes presenting the advertisement to the customer via the network communication link when the print processing system controller receives the job ticket for the print job.

10. The method of claim 1, wherein the step of processing the job ticket includes generating and submitting the job ticket for the print job to the print processing system controller, and wherein the step of presenting the advertisement includes presenting the advertisement to the customer via the network communication link when the job ticket for the print job is generated.

11. A method of processing a print job of a customer and directing advertising to the customer, the method comprising the steps of:
defining a print processing system controller having a plurality of advertisements registered therewith;
defining a network communication link between the customer and the print processing system controller;
processing a job ticket for the print job with the print processing system controller and selecting at least one of the advertisements based on the job ticket; and
presenting the at least one of the advertisements to the customer via the network communication link.

12. The method of claim 11, wherein the step of defining the network communication link includes defining an Internet communication link between the customer and the print processing system controller.

13. The method of claim 11, wherein the step of processing the job ticket and selecting the at least one of the advertisements includes receiving a plurality of attributes for the print job at the print processing system controller and selecting the at least one of the advertisements based on at least one of the attributes for the print job.

14. The method of claim 13, wherein receiving the plurality of attributes for the print job includes receiving at least one of a file format, a number of copies, a print medium, a printing layout, a printing quality option, a color printing option, a finishing option, a delivery option, and a customer identification for the print job.

15. The method of claim 11, further comprising the step of:
registering the advertisements with the print processing system controller.

16. The method of claim 15, wherein the step of defining the network communication link includes defining the network communication link between a plurality of advertisers, the customer, and the print processing system controller, and wherein the step of registering the advertisements includes registering the advertisements with the print processing system controller via the network communication link.

17. The method of claim 15, wherein the step of registering the advertisements includes storing the advertisements, and wherein the step of presenting the at least one of the advertisements includes retrieving the at least one of the advertisements.

18. The method of claim 11, wherein the step of presenting the at least one of the advertisements to the customer includes presenting the at least one of the advertisements to the customer via the network communication link when the print processing system controller processes the job ticket for the print job.

19. The method of claim 11, wherein the step of processing the job ticket includes receiving the job ticket for the print job at the print processing system controller, and wherein the step of presenting the at least one of the advertisements includes presenting the at least one of the advertisements to the customer via the network communication link when the print processing system controller receives the job ticket for the print job.

20. The method of claim 11, wherein the step of processing the job ticket includes generating and submitting the job ticket for the print job to the print processing system controller, and wherein the step of presenting the at least one of the advertisements includes presenting the at least one of the advertisements to the customer via the network communication link when the job ticket for the print job is generated.

21. A system for processing a print job of a customer and directing advertising to the customer, the system comprising:
a print processing system controller configured to have an advertisement registered therewith, wherein the print processing system controller is adapted to process a job ticket for the print job and present the advertisement to the customer when the print processing system controller processes the job ticket for the print job.

22. The system of claim 21, wherein the print processing system controller is configured to communicate with the customer via a network communication link, and wherein the print processing system controller is adapted to present the advertisement to the customer via the network communication link.

23. The system of claim 22, wherein the network communication link is an Internet communication link.

24. The system of claim 21, wherein the print processing system controller is configured to have a plurality of advertisements registered therewith, and wherein the print processing system controller is adapted to present at least one of the advertisements to the customer.

25. The system of claim 24, wherein the print processing system controller is adapted to receive a plurality of attributes for the print job and select the at least one of the advertisements based on at least one of the attributes for the print job.

26. The system of claim 25, wherein the attributes for the print job include at least one of a file format, a number of copies, a print medium, a printing layout, a printing quality option, a color printing option, a finishing option, a delivery option, and a customer identification for the print job.

27. The system of claim 21, further comprising:
a customer interface configured to communicate with the print processing system controller via a network communication link to transmit the job ticket for the print job to the print processing system controller.

28. The system of claim 27, wherein the network communication link is an Internet communication link.

29. The system of claim 27, wherein the customer interface includes an advertisement field and at least one a file format field, a number of copies field, a print medium field, a printing layout field, a printing quality option field, a color printing option field, a finishing option field, a delivery option field, and a customer identification field.

30. The system of claim 21, wherein the print processing system controller is configured to communicate with at least one advertiser via a network communication link, and wherein the print processing system controller is adapted to receive at least one advertisement from the at least one advertiser via the network communication link.

31. The system of claim 30, wherein the network communication link is an Internet communication link.

32. The system of claim 21, further comprising:
a print processing data storage system configured to communicate with the print processing system controller and store the advertisement therein.

33. The system of claim 21, wherein the print processing system controller is adapted to present the advertisement to the customer when the job ticket for the print job is generated.

34. The system of claim 21, wherein the print processing system controller is adapted to receive the job ticket for the print job and present the advertisement to the customer when the job ticket for the print job is received.
